(19) United States
(12) Patent Application Publication
(10) Pub. No.: US 2026/0049914 A1
(43) Pub. Date: Feb. 19, 2026

(54) CONTROLLING A MATERIAL TESTING SYSTEM

(71) Applicant: TA Instruments-Waters LLC, New Castle, DE (US)

(72) Inventors: Akshay Palle, Newark, DE (US); David L. Dingmann, Saint Paul, MN (US)

(21) Appl. No.: 19/294,713

(22) Filed: Aug. 8, 2025

Related U.S. Application Data
(60) Provisional application No. 63/682,648, filed on Aug. 13, 2024.

(51) Int. Cl. G01N 3/08

(52) U.S. Cl. CPC G01N 3/08; G01N 2203/0073

(57) ABSTRACT

Described is a method of controlling a material testing system that includes controlling an actuator to transfer a first force acting in a first direction to a test material. The method further includes receiving, via one or more sensors, continuous data indicating one or more physical quantities associated with the test material. Based upon the continuous data, it may be determined that a change in one or more physical quantities has occurred. Based upon a change in one or more physical quantities it may be determined that an end point of a material test has been reached. The method further includes controlling an actuator to stop transfer of the first force and further to controlling the actuate to transfer a second force which acts to counteract the effects of the first force and prevent unwanted motion of one or more portions of the material testing system.

### CROSS-REFERENCE TO RELATED APPLICATION

This application claims priority to U.S. Provisional Patent Application No. 63/682,648 filed on Aug. 13, 2024 and titled “Controlling a Material Testing System”, the entirety of which is incorporated by reference herein.

### FIELD OF INVENTION

The present invention relates generally to apparatus and methods for testing materials, and in particular to apparatus and methods for testing the break point and/or fatigue point of materials.

### BACKGROUND

It is known to test various physical properties and limits of a material by employing a material testing system. Testing systems may use an actuator or similar device attached to a test material to impart a force to the material. Such force may be applied for the purposes of determining a level of force, displacement, or other suitable metrics at which a test material will break, deform, or otherwise alter from its original state, or to determine various physical properties of the material. Furthermore, it is known to be advantageous to maintain the material in its broken, deformed, or otherwise altered state without further breaking, deforming, or otherwise altering the material further after the initial break, deformation, or otherwise alteration. This is because there may be valuable material information that can be obtained from the portion of the material which broke, deformed, or otherwise became altered.

When a material breaks, deforms, or becomes altered through the course of a material test, the force being applied up to that point may result in portions of the material testing system inadvertently gaining momentum in the direction of the force application. For example, if a material is being pulled and suffers a break, an actuator may gain momentum in the direction of the force pulling on the material prior to the break. In some cases, uncontrolled momentum of the actuator or other portions of the material testing system can result in collisions with other portions of the material testing system. This can result in damage either in the form of immediate damage or increased wear and tear of the testing system. Typically, a material testing system will employ countermeasures such as rubber bump stops which may act to soften impacts and reduce the rapidity with which damage accumulates.

It is known therefore that it is advantageous to stop the uncontrolled motion of portions of the testing system prior to any collisions. Disadvantageously, this currently requires knowledge of the material being tested in sufficient detail so as to predict a breakage, deformation, or otherwise alteration point of the material in order to program in a stopping point of the actuator or other portions of the testing system. For example, if it is known that an average material will break around 10 mm of displacement from the starting point of the test, the testing system can be programmed to stop at 11 mm of displacement. This method cannot account for new materials, outlier tests, or any other unforeseen circumstances in the testing environment.

It is desired to provide an improved method of controlling a material testing system and an improved material testing system.

### SUMMARY OF THE INVENTION

Exemplary aspects of the invention relate to a method, as well as non-transitory computer-readable storage mediums storing instructions for performing the methods and a material testing system comprising, amongst other things, a controlling unit comprising a non-transitory computer-readable storage medium storing logic for performing the method and a processor configured to execute that logic.

According to an aspect of the invention there is provided a method of controlling a material testing system. The method includes controlling an actuator to transfer a first force acting in a first direction to a test material. The method further includes receiving, via one or more sensors, continuous data indicating one or more physical quantities associated with the test material. Based upon, at least in part, the continuous data indicating one or more physical quantities, it may be determined that a change in one or more physical quantities has occurred. Based upon, at least in part, a change in one or more physical quantities it may be determined that an end point of a material test has been reached. The method further includes controlling an actuator to stop transfer of the first force and further to controlling the actuate to transfer a second force which acts, at least in part, to counteract the effects of the first force and prevent, at least in part, unwanted motion of one or more portions of the material testing system.

According to a further aspect of the invention the method may include causing a test material to reach a resting position, at least in part due to a second force, where the second force is a braking force.

According to a further aspect of the invention, one or more physical quantities associated with a test material may be at least one of a Young's modulus, a tan delta, a storage modulus, a loss modulus, a stress, a strain, a deformation, a displacement, a mechanical load, and a stiffness.

According to a further aspect of the invention, the stiffness of a test material may be detected, via one or more logic circuits in communication with the one or more sensors, to have reached a threshold value and furthermore it may be determined that an end point of the material test has been reached based at least in part on that threshold value being reached.

According to a further aspect of the invention, a threshold value for the stiffness of a test material may be zero.

According to a further aspect of the invention, a brake force magnitude corresponding to the second force may be proportional to a test force magnitude corresponding to the first force when it determined that an end point of a material test has been reached.

According to a further aspect of the invention, the method may further include controlling an actuator to transfer a third force to a test material which acts to move the test material from a resting position to a set point after a second force has been transferred once an end point of the material test has been reached and the first force has stopped being applied.

According to a further aspect of the invention, an end point of a material test may be associated with a break in the test material.

According to a further aspect of the invention, an end point of a material test may be associated with a fatigued state of the test material.

According to a further aspect of the invention, the method may further include controlling the first force and the second force to have varying magnitudes.

According to a further aspect of the invention, a physical quantity of a test material may be detected, via one or more logic circuits in communication with the one or more sensors, to have reached a threshold value and furthermore it may be determined that an end point of the material test has been reached based at least in part on that threshold value being reached.

### BRIEF DESCRIPTION OF THE DRAWINGS

Various embodiments will now be described, by way of example only, and with reference to the accompanying drawings in which:

FIG. 1 illustrates a schematic of a material testing system;

FIG. 2 illustrates a method of operating a material testing system according to various embodiments of the invention;

FIG. 3 illustrates a method of operating a material testing system according to various embodiments of the invention;

FIG. 4A illustrates a portion of a material testing system including a test material;

FIG. 4B illustrates a portion of a material testing system including a test material after an end point of the test has been reached

FIGS. 5A-5B illustrate logic circuits according to various embodiments of the invention;

FIG. 6 illustrates a logic circuit according to various embodiments of the invention; and

FIG. 7 illustrates the results of a material test according to various embodiments of the invention.

### DETAILED DESCRIPTION

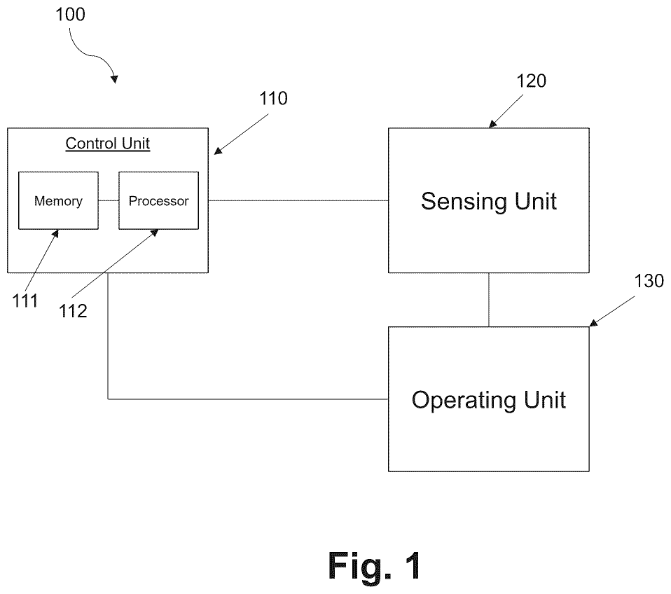

FIG. 1 shows a schematic of a material testing system 100. The material testing system 100 may include a control unit 110 including a memory 111 and processor 112. The memory 111 stores instructions for controlling the material testing system 100 which may be executed by the processor 112 to control the material testing system 100. The control unit 110 may be contained within the material testing system 100 as shown in FIG. 1 or it may be a separate computing device connected to the material testing system 100 either directly or via a lab management of cloud service system. The control unit 110 is connected to both a sensing unit 120 and an operating unit 130. The sensing unit 120 may be connected to the operating unit 130.

The sensing unit 120 may include one or more sensors which may detect a status of the material testing system 100, the operating unit 130 and/or any test material contained therein during a material test. For example, the sensing unit may include temperature sensors for detecting a temperature of the room, a temperature of the material testing system 100, a temperature of a material included within the operating unit 130. The sensing unit 120 may further include force and/or displacement sensors for detecting a force applied to the test material and displacement of test material and/or a portion of the operating unit 130. The sensing unit 120 may further include sensors for determining physical quantities of the test material included within the operating unit, these sensors may include sensors which detect one or more of stress, strain, Young's modulus number, tan delta, loss modulus, storage modulus, stiffness, and other physical quantities of the test material. While specific examples have been given, it will be appreciated that the sensing unit 120 may include a sensor for detecting any physical quantity of the material testing system 100, including the operating unit 130 and a test material. Furthermore, the sensing unit 120 may include sensors for determining qualities of the environment exterior to the material testing system 100. For example, the ambient temperature levels in a lab for conducting the material test and other environmental conditions which may affect properties of the test material or material testing system 100. Therefore, the physical quantity being measured may be any aspect of the test material, the material testing system, and or the environment around the material testing system.

The sensing unit may be a standalone unit connected as shown in FIG. 1 or it may be incorporated into one or more other units including the control unit 110 or operating unit 120 and may further comprise either one or more sensors capable of sensing more than one physical quantity of the test material and environment and/or may comprise one or more sensors specialized to sense one physical quantity of the test material or environment. When the sensing unit senses a physical quantity, it may communicate this information back to the control unit 110 as data whereupon the control unit 110 may store the information in memory 111 and process the information in the processor 112. The control unit 110 may then control the sensing unit 120 and or operating unit 130 to adjust an aspect of the material test or the material testing system. For example, the control unit 110 may control the operating unit 130 to begin, cease, or otherwise alter its operation.

The operating unit 130 may include one or more actuators, motors, or other means of transferring force. These means may operate electrically, mechanically, hydraulically, or any other method which would impart suitable levels of force and control. The operating unit 130 may further include means for holding a test material. For example, the operating unit 130 may include means which restrict motion of the test material outside of that introduced during normal operation of a material test. For example, the operating unit 130 may include a portion for receiving a part of the test material such that a user or automated system can place the test material inside said portion and said portion then prevents further movement of the test material. The operating unit 130 may also include a second portion for receiving a part of the test material such that a user or automated system can place the test material inside said portion and said portion then prevents further movement of the test material. The receiving portions of the operating unit 130 may be adapted to be specific to the test material or may be capable of receiving a variety of different test materials while retaining their function. In other examples, the operating unit 130 may include further receiving portions for receiving the test material, for example it may include three, four, or more receiving portions each for receiving a part of the test material. The receiving portion may, in some examples, be a vice grip, a mechanical press, or other mechanism to hold the test material via friction and or pressure. In other examples, the receiving portion may contain a locking mechanism into which part of the test material is placed and subsequently locked into place, for example by moving from an open to a closed position of a locking mechanism or from a disengaged state to an engaged state. In other examples, combinations of the previously mentioned mechanisms may be used.

In some examples, the one or more actuators, motors, or other means of transferring force of the operating unit 130 may act on the test material through only one of the receiving portions and in other examples they may act on the test material through more than one of the receiving portions. In some examples, the force transferred may be different at each of the more than one receiving portions. During a material test, the operating unit 130 includes a test material and the one or more actuators, motors, or other means of transferring force of the operating unit 130 can be controlled by the control unit 110 to transfer force via the receiving parts of the operating unit 130 to the test material. The control unit 110 may control the operating unit 130 to transfer a steady force, that is a force with a constant magnitude, or the magnitude of the force transferred may vary during a material test. In some examples, the control unit 110 may control the operating unit 130 such that the magnitude of the force transferred changes in response to the control unit 110 receiving data associated with a physical quantity from the sensing unit 120.

Although the control unit 110, sensing unit 120, and operating unit 130 are shown in FIG. 1 to be distinct units, they may in some examples form a singular mechanism or be distributed such that one unit is comprised within another unit. Furthermore, each unit may include elements relating to another unit, for example the operating unit 130 may include sensors that would form part of the sensing unit 120 because said sensors are required to be in direct contact with portions of the operating unit 130. It is to be understood that the material testing system 100 illustrated in FIG. 1 is illustrated by way of example only and any suitable combination of the units comprising the material testing system 100 may be employed.

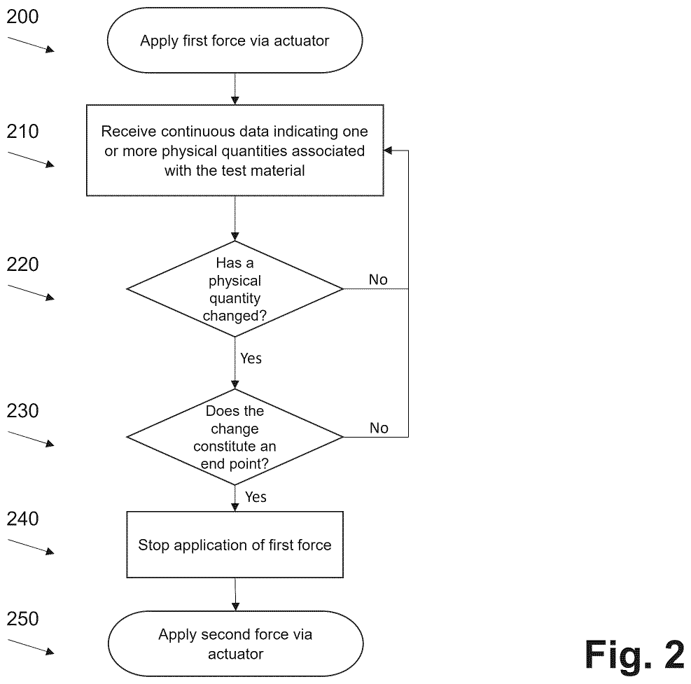

FIG. 2 shows a method of controlling a material testing system 100 according to various embodiments. The material testing system 100 is arranged such that a test material is present within the operating unit 130. At step 200, the control unit 110 controls the operating unit 130 to apply a first force to the test material. In FIG. 2 the first force is applied via actuator, but it will be appreciated that the first force may also be applied to the test material by a motor or other means of transferring force. In some examples, the first force may be a single force applied to the test material in a single direction. In some examples, the test material may be held in two receiving parts of the operating unit 130 and the first force transferred may act to pull the test material in the direction of one of the receiving parts while it is held from moving in another direction by the other receiving part. In other examples, the first force may be a single force applied to the test material which varies in direction. In other examples, the first force may be more than one force that is applied to the test material in opposing directions. In yet other examples, the first force may be more than one force that is applied to the test material in various directions. In other examples, the first force may be applied in a non-continuous manner such that the test material is subject to more than one period without a force applied and more than one other period with the first force applied in sequence.

At step 210, the sensing unit 120 continuously senses one or more physical quantities associated with the test material, including the material testing system, and or the environment and communicates this data to the control unit 110. While step 210 is presented as occurring after step 200 in this example, it will be appreciated that in some examples the sensing unit 120 continuously gathers sensing data such that the initial application of the first force and the conditions immediately prior to said application are captured in the data. In some examples, continuous data is collected such that one or more physical quantities are recorded in an unbroken chain in real time and in other examples, the continuous data may be interrupted by a pause in the material test and resumed at the same time point upon resumption of the material test, i.e. the data is continuous for the time of the material test operation. The continuous data therefore may be continuous in either real time or operation time. In some examples, the continuous data may be a combination whereby the continuous data may be real time for some physical quantities and the continuous data may be operation time for other physical quantities.

At step 220 the control unit 110 determines if there has been a change in one or more physical quantities based upon the data received from the sensor unit 120. For example, it may be determined that the magnitude of a physical quantity has increased or decreased. If no physical quantity has changed then step 210 is repeated. If the control unit 110 determines that one or more physical quantities have changed, it proceeds to step 230 and determines if the change in the one or more physical quantities constitutes an end point of the material test. If it is determined that an end point of the material test has not been reached then step 210 is repeated. In some examples, the end point of the material test may be after a pre-set time limit has been reached or a pre-set number of applications of the first force in sequence has been reached. In other examples, the end point may be when one or more physical quantities increase or decrease to a threshold value. For example, if a material breaks due to the force applied to it, the mechanical load or stress for the test material will instantly decrease to zero. In this example if the threshold value for mechanical load or stress for the test material is set to zero then the end point will be reached when the mechanical load or stress reaches zero. Another example of an end point is if a test material deforms under the applied force, a physical quantity representing that deformation, for example displacement from origin, may reach a threshold value. Another example of an end point is if the stiffness of the test material reaches a threshold value, for example during a fatigue test of the material. Another example of an end point is a fatigued state of a test material, which may in some examples be reached once a deformation of the test material reaches a threshold value, or may be reached after a certain time period, or may be reached after another physical quantity of the test material reaches a threshold value.

If, at step 230, it is determined that an end point has been reached then at step 240 the control unit 110 controls the operating unit 130 to stop application of the first force. The stopping of the application of the first force may be instantaneous or it may occur over a pre-defined time period, or it may occur over a time period determined by the control unit 110 to be optimal for the conditions of the material test.

At step 250, the control unit 110 controls the operating unit 130 to apply a second force to the test material. In FIG. 2 the second force is applied via actuator, but it will be appreciated that the second force may also be applied to the test material by a motor or other means of transferring force. In some examples, the second force may be a single force applied to the test material in a single direction. In some examples, the test material may be held in two receiving parts of the operating unit 130 and the second force transferred may act to push the test material in the direction of one of the receiving parts while it is held from moving in another direction by the other receiving part. In other examples, the second force may be a single force applied to the test material which varies in direction. In other examples, the second force may be more than one force that is applied to the test material in opposing directions. In yet other examples, the second force may be more than one force that is applied to the test material in various directions. In some examples, if the end point of the material test in step 230 coincides with a break of the test material, it will be appreciated that the second force may be applied to either a portion of the test material or the whole of the test material. In some examples, if the test material was situated in and between two receiving parts of the operating unit 130 and was pulled in the direction of one of the receiving parts by the first force while being held in place by the other receiving part, the test material may suffer a break. In this example, the test material breaks into two portions and the second force may be applied to only one of the portions of the test material.

The second force applied in step 250 may be a braking force. That is, the second force may act to counteract, at least in part, the effects of the first force to bring the test material and operating unit 130 to a resting position. In the resting position, the momentum of the test material and operating unit 130 is zero. The second force is applied at a magnitude and for a duration which will necessarily bring the test material and operating unit 130 to a resting position. In some examples, the second force may directly counteract the effects such that if the first force acted to pull the test material along an axis, the second the force may act to push the test material along that same axis in the opposite direction to the pull of the first force. In other examples, the second force may indirectly counteract the effects such that the direction of the first and second force are not directly opposed. In some examples, the magnitude of the first force and the magnitude of the second force may be equal such that the second force would entirely cancel out the first force if they were applied at the same time. In other examples, the magnitude of the second force may be proportional to the magnitude of the first force.

In one example, the material test comprises a test material situated in and between two receiving parts of the operating unit 130 distributed along an axis. During the material test, the first force is applied to the test material as a pulling force in the direction of one of the receiving parts. During the material test, the controlling unit 110 determines, via data acquired by the sensing unit 120, that a break has occurred in the test material as the stress has decreased to the threshold value of zero. The control unit 110 controls the operating unit 130 to stop applying the first force. In this example, the test material breaks into two portions, one situated in and extending away from each respective receiving part. The portion of the test material and the operating unit 130 which were subject to the first force will gain momentum in the direction of the first force before the first force has stopped being transferred. In this example, the control unit controls the operating unit 130 to apply a second force directly in opposition to the direction of the first force for a determined duration to bring the test material and operating unit 130 to a resting position.

In some examples, the magnitude of the second force may be proportional to the first force due to constraints of the material testing system 100. For example, if the response time of the control unit 110 instructing the operating unit 130 is 10 ms, the first force will have been applied to the broken portion of the test material and portion of the operating unit 130 for those 10 ms, causing them to gain additional momentum in the direction of the first force. In this example, if the second force has equal magnitude to the first force it may not bring the test material to a resting position in a short enough timeframe to prevent damage to the material testing system 100. The control unit 110 is pre-programmed to increase the magnitude of the second force in proportion to the magnitude of the first force to cancel out the increased momentum and bring the test material and operating unit 130 to a resting position in a short enough timeframe to prevent damage to the material testing system 100. In this example the control unit 110 is pre-programmed to increase the magnitude of the second force by a certain proportion of the first force, but in other examples the control unit 110 may automatically determine a necessary change to the magnitude of the second force to achieve a resting position within a certain timeframe. In other examples, the control unit may utilize details of a test material contained within a materials database stored within the memory 111 to determine an appropriate change to the magnitude of the second force.

While not every material test will result in a break, testing of materials with unknown properties, outlier tests, or any other unforeseen circumstances in the testing environment may result in an unexpected break. If a second force is not applied to brake the test material and the operating unit 130 then portions of the operating unit 130 may impact other portions of the operating unit 130 or material testing system 100. Such impacts can cause immediate damage as well as increase the wear and tear on the material testing system 100, resulting in increased levels of required service and maintenance and reducing the working lifetime of the system.

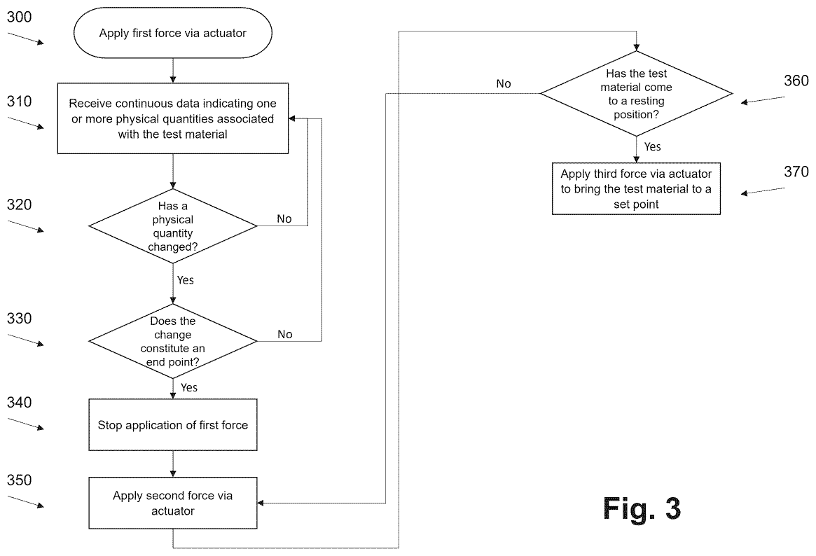

Referring now to FIG. 3, a method of controlling a material testing system 100 according to various embodiments is shown. Steps 310, 320, 330, 340, and 350 may be equivalent to steps 210, 220, 230, 240, and 250 of FIG. 2 respectively. At step 360, the control unit 110 determines, via data from the sensing unit 120, if the test material and operating unit 130 are in a resting position. If the test material and operating unit 130 are not in a resting position, the second force continues to be applied as in step 350. If it is determined that a resting position has been reached, the control unit 110 controls the operating unit 130 to apply a third force in step 370. In some examples the third force is applied to one or more portions of the test material. The third force acts to bring the operating unit 130 from a resting position to a set point. The set point is a second resting position such that the momentum of the test material and operating unit 130 is zero at the set point. The set point may be pre-determined by a user or may be pre-determined by the manufacturer of the system. In some examples, the set point is a point where two portions of a broken test material are in close proximity without impacting or connecting. If broken portions of a test material impact or connect, a user may not be able to observe information about the test material from the broken portions. In some examples, the third force may be applied as a singular impetus or for only a short timeframe in order to move the system to the set point. In other examples, the third force may be applied over a longer timeframe at a reduced magnitude in order to move the system to the set point. In other examples, the magnitude of the third force may vary across the time period necessary to reach the set point. In yet other examples, the third force may comprise an initial force and a secondary braking force to bring the system to the set point.

Larger displacements of the test material and portions of the operating unit 130 may increase wear and tear on the system and may in some cases increase the chance of errors in the application of the second or third force even if a resting position is reached after a large displacement but before an impact has occurred. In some examples, the control unit 110 may be pre-programmed to control the operating unit 130 to apply the second force such that a resting position is reached within 10 mm of displacement from the point at which an end point was reached. The control unit 110 may be pre-programmed in this manner by a user or may be pre-programmed by the manufacturer of the system.

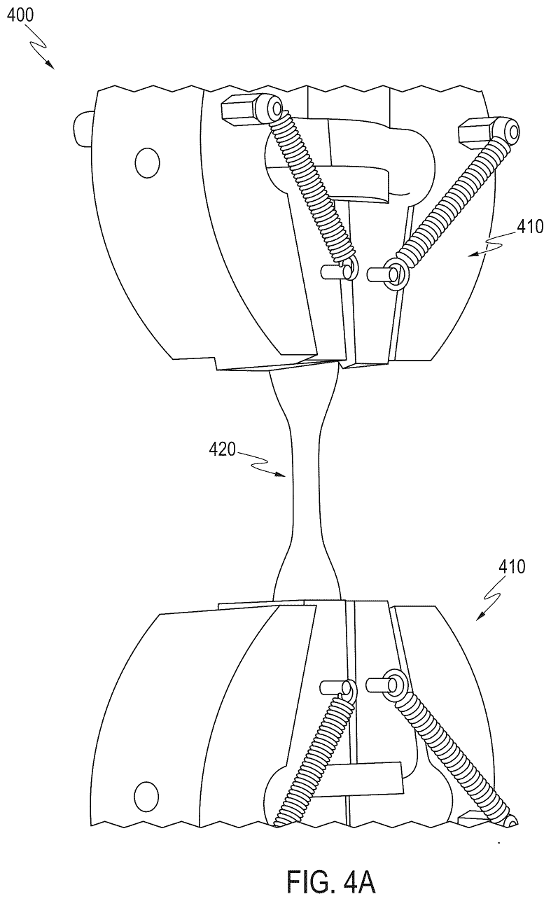

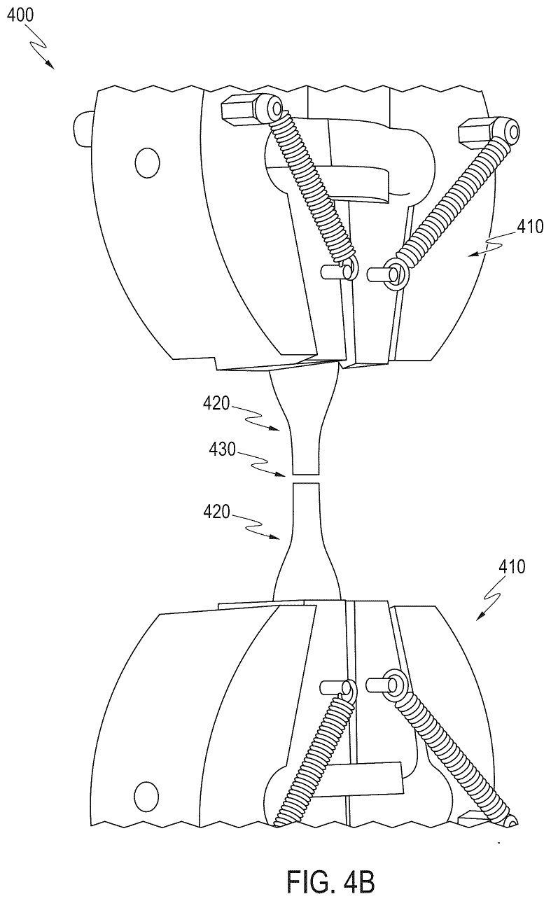

FIG. 4A shows an example of a portion of a material testing system according to various embodiments. A portion of an operating unit 400 includes receiving parts 410 for receiving portions of a test material 420. In this example, the test material is situated in and between each of the receiving portions of the operating unit 400. In this example, a material test has not yet been initiated and the system is at rest.

FIG. 4B shows an example of the portion of an operating unit 400 of FIG. 4A after an end point has been reached during a material test. In this example, the end point of the material test occurred when the test material experienced a break 430 and the measured stress of the test material reached zero. In this example, the operating unit 400 has reached a resting point after the end point has been reached. In some examples, this resting point is resultant of the application of a second force and in other examples this resting point is the set point resultant of the application of a third force. It can be seen that the two portions of the test material are arranged such that the break 430 is clearly visible along with the end of each portion of the test material at which the break 430 occurred and the portions of the test material 420 and receiving parts are minimally displaced from each other.

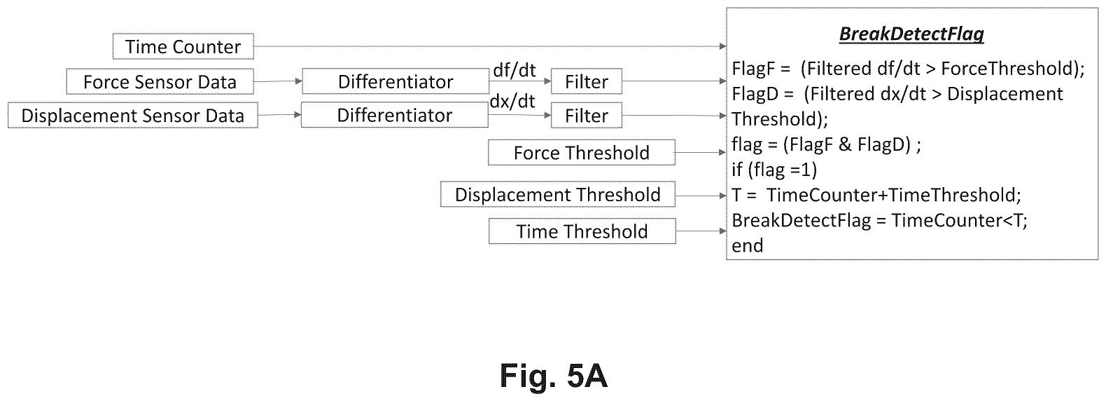

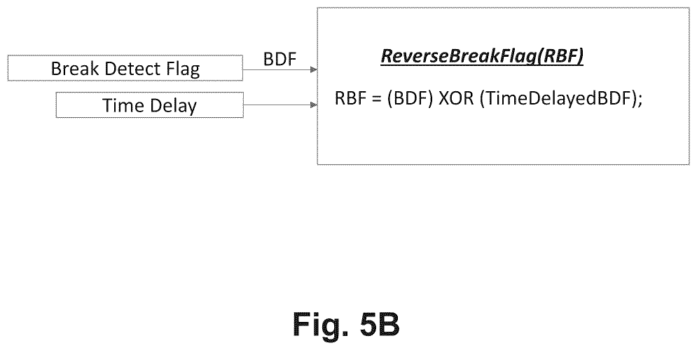

FIG. 5A shows an example of a logic circuit according to various embodiments of the invention which can be used by the control unit 110 to detect a break in a test material during a material test. In some examples, the logic circuit continuously processes sensor data relating to various physical quantities from the sensing unit 120. In such and other examples, the logic circuit can be used by the control unit 110 to determine a break in a test material once one or more of the physical quantities being processed reaches a threshold value. A break in a test material may constitute an end point of the material test depending upon the parameters of the material test being conducted. If a break in a test material has been determined, the control unit 110 may use a logic circuit to flag that a break has occurred and proceed through one or more further logic circuits.

FIG. 5B shows an example of a logic circuit according to various embodiments of the invention which can be used by the control unit 110 to help determine an appropriate magnitude of a second force. In some examples, the sensing unit 120 continuously relays sensor data to the control unit 110 including the magnitude of the first force applied to the test material. The control unit 110 may control the operating unit 130 to transfer a second force at a magnitude that is proportional to the first force at the time point at which a break was determined to occur in a test material. In FIG. 5B, the example logic circuit includes a time delay function which may be used by the control unit 110 in some examples to automatically scale the magnitude of the second force proportionally to the magnitude of the first force being transferred at the determined end point. For example, if it is known that there is an inherent signal delay in a material testing system which would allow for a period of uncontrolled acceleration of a test material and or portion of an operating unit 130 after a break in a test material, a time delay modifier may be applied to correct for the increased momentum of the test material and or portion of an operating unit 130 to bring the system to a resting point without impact. The time delay may be pre-determined by a user or may be pre-determined by the manufacturer of the system.

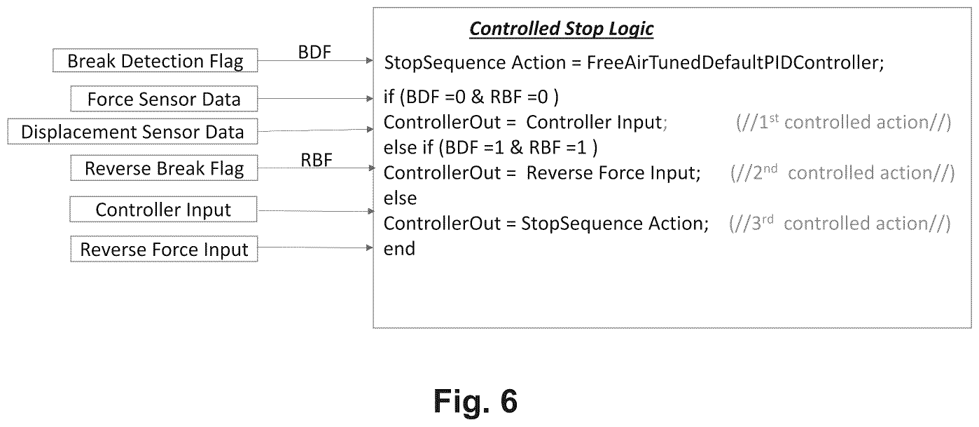

FIG. 6 shows an example of a logic circuit according to various embodiments of the invention which comprises elements of logic circuits according to FIGS. 5A-5B and which is used by the control unit 110 to control the operating unit 130 across a material test including a break in a test material as end point of the material test. In some examples, a first controlled action may be transferal of a first force, a second controlled action may be transferal of a second force, and a third controlled action may be transferal of a third force. In some examples, the first force may be a test and force and in some examples the second force may be a brake force. In some examples, the control unit 110 undertakes a first controlled action until a break is detected in a test material at which time the first controlled action is stopped. Subsequently, the control unit 110 may undertake a second controlled action until a resting position of the system is reached. Further, the control unit 110 may undertake a third controlled action until a set point of the system is reached. In some examples, the second controlled action may include transferal of a braking force after a break has been detected in a test material during a material test. Said braking force may be proportional to a force transferred in the first controlled action or may be a constant value which may be predetermined by a user or may be pre-determined by the manufacturer of the system either universally or dependent upon a known test material or test material of partially known properties. In some examples, the third controlled action may include transferal of a third force after a resting position has been reached through the second controlled action. The third controlled action may bring the system to a set point which may be the last sensed displacement of the test material or portion of the operating unit 130 before a break was detected, may be proportional to said last sensed displacement, or may be pre-determined by a user or a manufacturer of the system. In some examples, the set point may be proportional to the last sensed displacement prior to a break such that a pre-determined distance between portions of a broken test material is obtained at the set point, where said pre-determined distance may be selected by a user or a manufacturer of the system.

While certain examples have been shown, it will be appreciated that other logic circuits may be used by the control unit 110 to control the material testing system 100. In some examples, logic circuits for estimating or otherwise determining the stiffness of a test material be used. In some examples, the control unit 110 may include logic circuits with specific and narrow functions and in other examples the control unit 110 may include multi-purpose logic circuits with varying functions.

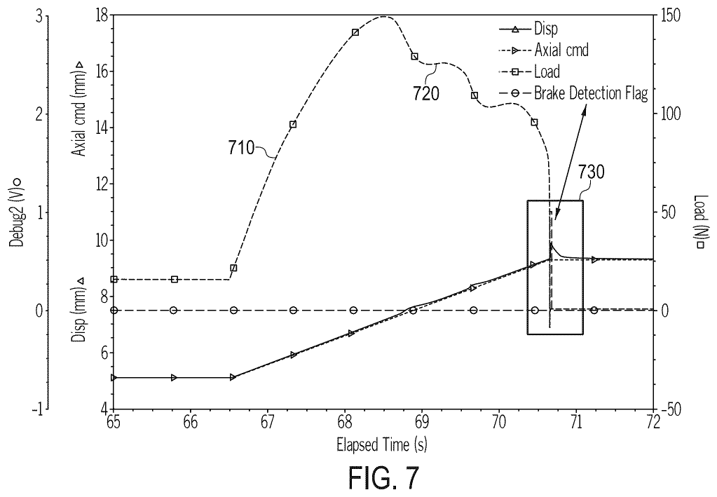

FIG. 7 shows an example of a continuous data set for more than one physical quantity in a material test according to various embodiments of the invention. In this example the physical quantities of displacement, axial cmd, and load are displayed across a continuous time period for the duration of a material test. At initial curve 710 the load on the test material can be seen to be increasing as a first force is applied via one or more actuators, motors, or other means of transferring force. Axial cmd and displacement are also seen to increase at initial curve 710 as the test material deforms under the effects of the first force. In the example shown in FIG. 7, the material test has been conducted under displacement conditions. That is, the test is intended to transfer force to incrementally increase displacement of a test material or a portion of an operating unit 130 until a break is detected. For example, the test may be conducted such that sufficient force is transferred to displace the test material by 1 mm per set time period. The physical quantity axial cmd in FIG. 7 is the intended displacement of the test material, which can be seen to increase to a point and then remain constant while the measured displacement increases further due to a break in the test material. In other examples, a material test may be conducted under force conditions. That is, rather than axial cmd, a physical quantity for force applied to the test material may be displayed. In such examples, the force applied may be a first force and may be constant or variable depending upon the parameters of the material test being conducted.

At secondary curve 720 the load on the test material can be seen to vary while displacement and axial cmd continue to increase. At the time point corresponding to break point 730 the load can be seen to decrease to zero as the test material breaks resulting in a sharp increase in displacement before application of a second force which prevents further displacement in the direction of the first force and subsequently the application of a third force which more gradually displaces the test material back towards a set point.

The results shown in FIG. 7 including initial curve 710, secondary curve 720, and break point 730 are dependent upon the test material being tested and FIG. 7 is an example of one test material only. Results for test materials may appear visually similar or distinct to FIG. 7 depending upon their specific characteristics.

Although the present invention has been described with reference to various embodiments and examples, it will be understood by those skilled in the art that various changes in form and detail may be made without departing from the scope of the invention as set forth in the accompanying claims.

1. A method of controlling a material testing system comprising:
controlling an actuator to actuate to transfer a first force, acting in a first direction, to a test material
receiving, via one or more sensors, continuous data indicating one or more physical quantities associated with the test material
determining, based upon, at least in part, a portion of the continuous data, a change in one or more physical quantities associated with the test material
determining that an end point of the material test has been reached based upon, at least in part, the determining of the change in the one or more physical quantities
controlling the actuator to stop transfer of the first force; and
controlling the actuator to actuate to transfer a second force which acts, at least in part, to counteract the effects of the first force and prevent, at least in part, unwanted motion of one or more portions of the material testing system.

2. A method in accordance with claim 1, further comprising:
causing, at least in part by the second force, the test material to reach a resting position, wherein the second force is a braking force.

3. A method in accordance with claim 1, wherein the one or more physical quantities associated with the test material comprises at least one of: a Young's modulus, a tan delta, a storage modulus, a loss modulus, a stress, a strain, a deformation, a displacement, a mechanical load, and a stiffness.

4. A method in accordance with claim 1, further comprising:
detecting, via one or more logic circuits in communication with the one or more sensors, that the stiffness of the test material has reached a threshold value; and
wherein determining that the end point of the material test has been reached is based upon, at least in part, the detecting that the stiffness of the test material has reached the threshold value.

5. A method in accordance with claim 4, wherein said threshold value is zero.

6. A method in accordance with claim 1, wherein a brake force magnitude corresponding to the second force is proportional to a test force magnitude corresponding to the first force when it is determined that an end point of the material test has been reached.

7. A method in accordance with claim 1, further comprising:
controlling the actuator to actuate to transfer a third force which acts to move the test material to a set point after the end point of the material test has been determined to have been reached and the second force has been transferred.

8. A method in accordance with claim 1, wherein the end point of the material test is associated with a break in the test material.

9. A method in accordance with claim 1, wherein the end point of the material test is associated with a fatigued state of the test material.

10. A method in accordance with claim 1, further comprising:
controlling the first force and the second force to have varying magnitudes.

11. A method in accordance with claim 1, further comprising:
determining that the one or more physical quantities of the test material have reached a threshold value; and
wherein determining that the end point of the material test has been reached is based upon, at least in part, the determining that the one or more physical quantities of the test material have reached the threshold value.

12. A material testing system comprising:
an operating unit comprising one or more actuators,
a test material disposed at least partially within said operating unit,
a sensing unit comprising one or more sensors; and
a controlling unit comprising a non-transitory computer-readable storage medium storing logic for performing the method of claim 1, and a processor configured to execute the logic.

13. A non-transitory computer-readable recording medium storing instructions that, when executed by one or more processors, cause the one or more processors to perform the method of claim 1.
